(19) United States
(12) Patent Application Publication
(10) Pub. No.: US 2007/0162255 A1
(43) Pub. Date: Jul. 12, 2007

(54) SURFACE TOPOGRAPHY DETECTOR AND METHOD FOR USE OF THE SAME

(75) Inventor: WEN-SSU CHIU, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,783

(22) Filed: Sep. 26, 2006

(30) Foreign Application Priority Data
Jan. 6, 2006 (CN) 200610032807.9

(51) Int. Cl. G01B 5/20; G01B 5/012

(52) U.S. Cl. 702/167; 702/127; 702/150

(57) ABSTRACT

A surface topography detector includes a first sensor, a second sensor and a digital control unit. The angle defined between the center axis of the first sensor and the center axis of the second sensor is equal to or less than 90 degrees. The digital control unit is electrically connected with the first sensor and the second sensor and is arranged for controlling the movement of the first sensor and the second sensor and processing the output signals of the first sensor and the second sensor. The surface topography detector can detect a surface with a bigger range of gradient angle accurately.

### FIELD OF THE INVENTION

The present invention relates to surface topography detecting technologies and, more particularly, to a surface topography detector and a method for detecting surface topography of a workpiece.

### DESCRIPTION OF RELATED ART

In recent years, mobile phones with cameras have been rapidly gaining in popularity. An aspherical lens used in mobile phone cameras can be as thin as about 1 mm whilst requiring a surface precision of about ±1 μm.

It is well known that lenses can be produced by injection molding, but one difficulty has always been apparent. In order to produce lenses with the desired level of precision, the molds used in the injection molding require an equally high level of precision.

Referring to FIG. 2, in a related surface topography machining process for an aspherical workpiece, a surface topography detector is usually used to detect surface topography of the aspherical workpiece. A conventional surface topography detector includes a sensor 2 and a digital control unit 3. The sensor 2 is used for detecting the surface of the workpiece. The digital control unit 3 is used for processing output signals from the sensor 2 and controlling movement of the sensor 2. When the conventional surface topography detector detects a surface 1, in order to get accurate information on the surface 1, an angle β formed between a center axis of the sensor 2 and a tangential plane of the surface 1 should be bigger than 45 degrees. The gradient angle of the axis of sensor 2 usually cannot change during surface topography detecting process. So, the surface topography detector with only one sensor 2 cannot accurately detect the surface 1 with a gradient angle θ bigger than 45 degrees.

What is needed, therefore, is a surface topography detector which can accurately detect a surface within a larger gradient angle range.

### SUMMARY OF THE INVENTION

In accordance with one embodiment, a surface topography detector includes a first sensor with a first central axis, a second sensor with a second central axis and a digital control unit. The angle defined between the first center axis and the second center axis is equal to or less than 90 degrees. The digital control unit is electrically connected with the first sensor and the second sensor and is configured for processing output signals from the first sensor and the second sensor and controlling movement of the first sensor and the second sensor.

In accordance with an embodiment, a method for detecting a surface topography of a workpiece includes the steps of: arranging a first sensor with a first central axis and a second sensor with a second central axis in a manner such that an angle is defined between the first center axis and the second center axis, the angle being equal to or less than 90 degrees; determining detecting locations of the first sensor and the second sensor; detecting the locations on the surface using the first sensor and the second sensor; and processing output signals from the first sensor and the second sensor thereby obtaining a result.

Other advantages and novel features of the present surface topography detector and method for detecting a surface topography of a workpiece will become more apparent from the following detailed description when taken in conjunction with the accompanying drawings.

### BRIEF DESCRIPTION OF THE DRAWINGS

Many aspects of the present surface topography detector and method for detecting a surface topography of a workpiece can be better understood with reference to the following drawings. The components in the drawings are not necessarily drawn to scale, the emphasis instead being placed upon clearly illustrating the principles of the present surface topography detector and method for detecting a surface topography of a workpiece. Moreover, in the drawings, like reference numerals designate corresponding parts throughout the several views.

FIG. 1 is a schematic, plan view of a surface topography detector according to a preferred embodiment of the present invention; and

FIG. 2 is a schematic, plan view of a conventional surface topography detector.

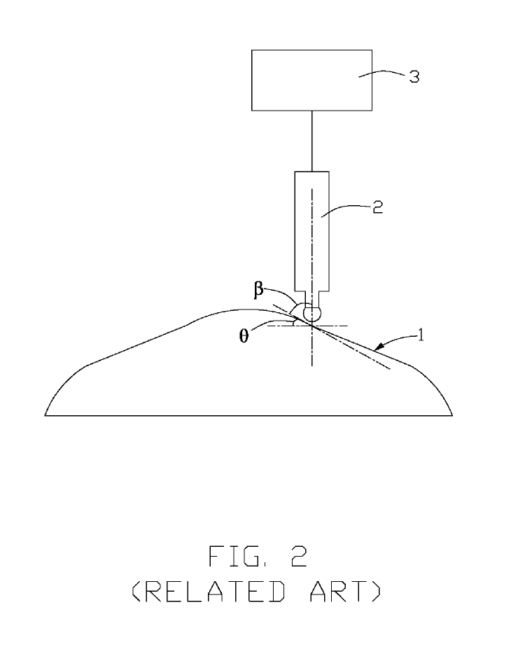

### DETAILED DESCRIPTION OF THE INVENTION

Embodiments of the present surface topography detector and method for detecting a surface topography of a workpiece will now be described in detail below and with reference to the drawings.

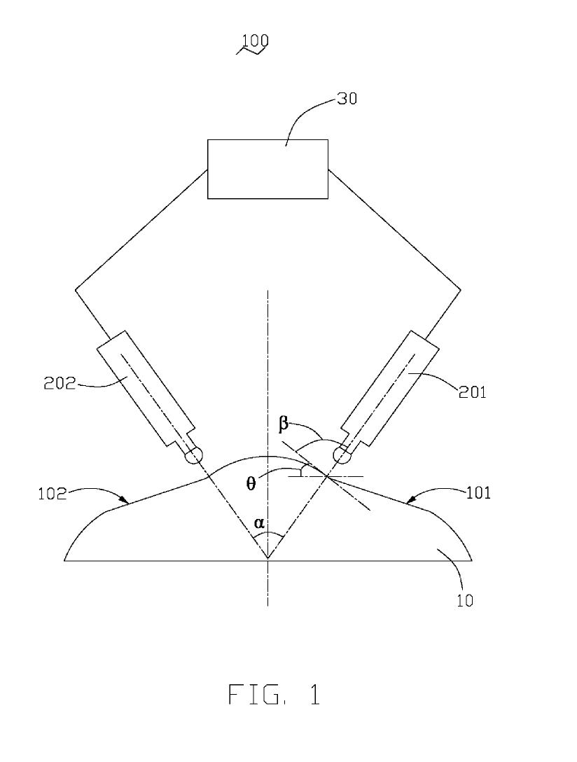

Referring to FIG. 1, a surface topography detector 100 according to a preferred embodiment includes a first sensor 201 with a first central axis, a second sensor 202 with a second central axis and a digital control unit 30. An angle α defined between the first center axis and the second center axis can be equal to or less than 90 degrees. The digital control unit 30 is electrically connected with the first sensor 201 and the second sensor 202. The digital control unit 30 is configured for processing output signals from the first sensor 201 and the second sensor 202 and controlling movement of the first sensor 201 and the second sensor 202.

The first sensor 201 and second sensor 202 can be optical interference sensors or inductive transducers. Preferably, the angle α defined between the first central axis of the first sensor 201 and the second center axis of the second sensor 202 is less than 90 degrees.

The digital control unit 30 can control the movement of the first sensor 201 and the second sensor 202. The digital control unit 30 can also process the output signals of the first sensor 201 and the second sensor 202, and obtain a detecting result. The output signals of the first sensor 201 and the second sensor 202 include information of surface topography of a detected location on the workpiece 10 and corresponding positions of the first sensor 201 and the second sensor 202.

Referring to FIG. 1, in operation of the surface topography detector 100, the first sensor 201 can detect a first surface 101 and the second sensor 202 can detect a second surface 102. The first surface 101 is a part of the surface of workpiece 10 at the right of a center axis of the surface of workpiece 10. The second surface 102 is a part of surface of workpiece 10 at the left of the center axis of the surface of workpiece 10. In order to get an accurate information of the first surface 101, the angle β defined between an center axis of the first sensor 201 and the tangential plane of the first surface 101 should be equal to or bigger than 45 degrees. Thus the first sensor 201 can accurately detect the first surface 101 with a gradient angle θ equal to or less than 45 degrees. Accordingly, the surface topography detector 100 with the first sensor 201 and the second sensor 202 can detect the workpiece 10 with a surface with a gradient angle θ equal to or less than 90 degrees.

Furthermore, the present invention also provides a method for detecting surface topography of a workpiece 10, according to an embodiment, the method includes the following steps.

First step: arranging a first sensor 201 with a first central axis and a second sensor 202 with a second central axis in a manner such that an angle α is defined between the first center axis and the second center axis, the angle being equal to or less than 90 degrees. The surface of the workpiece 10 has a gradient angle θ equal to or less than 90 degrees. The first sensor 201 and the second sensor 202 can be optical interference sensors or inductive transducers. The angle α can be set bases the gradient angle θ of the surface of the workpiece 10 insuring the angle defined between the first sensor 201 and the tangential plane of the first surface 101 and the angle defined between the second sensor 202 and the tangential plane of the second surface 102 are equal to or bigger than 45 degrees. The first sensor 201 takes charge of detecting the first surface 101 and the second sensor 202 takes charge of detecting the second surface 102. The detecting routes of the first sensor 201 and the second sensor 202 can be set by the program in a digital control unit 30. The angle α is unchangeable during surface topography detecting process.

Step 2: determining detecting locations of the first sensor 201 and the second sensor 202. In present embodiment, the first sensor 201 detects the first surface 101 and the second sensor 202 detects the second surface 102.

Step 3: detecting the locations on the surface using the first sensor and the second sensor.

Step 4: processing output signals from the first sensor 201 and the second sensor 202 thereby obtaining a detecting result. In the step 4, a digital control unit 30 is used for processing the output signals of the first sensor 201 and the second sensor 202 and obtaining a detecting result. The result of the detecting process can be gained by comparing the information on the surface of the workpiece 10 with information on a standard workpiece.

As stated above, the present surface topography detector and the method for detecting a surface topography of a workpiece use two sensors orientated at an angle α to detect a surface of a workpiece. Because each sensor can detect a surface with a gradient angle θ equal to or bigger than 45 degrees, the surface topography detector and the method for detecting a surface topography of a workpiece can detect a surface with a gradient angle θ equal to or less than 90 degrees. Accordingly, the present surface topography detector can detect a surface with a bigger range of gradient angle accurately.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A surface topography detector, comprising:
a first sensor with a first central axis;
a second sensor with a second central axis, the first sensor and the second sensor being arranged in a manner such that an angle equal to or less than 90 degrees is defined between the first center axis and the second center axis; and
a digital control unit electrically connected with the first sensor and the second sensor, the digital control unit being configured for processing output signals from the first sensor and the second sensor and controlling movement of the first sensor and the second sensor.

2. The surface topography detector as claimed in claim 1, wherein the first sensor or the second sensor is an optical interference sensor.

3. The surface topography detector as claimed in claim 1, wherein the first sensor or the second sensor is an inductive transducer.

4. The surface topography detector as claimed in claim 1, wherein the output signals from the first sensor and the second sensor include information on surface topography of a detected location on the workpiece and corresponding positions of the first sensor and the second sensor.

5. A method for detecting a surface topography of a workpiece, comprising the steps of:
arranging a first sensor with a first central axis and a second sensor with a second central axis in a manner such that an angle is defined between the first center axis and the second center axis, the angle being equal to or less than 90 degrees;
determining detecting locations of the first sensor and the second sensor;
detecting the locations on the surface using the first sensor and the second sensor; and
processing output signals from the first sensor and the second sensor thereby obtaining a detecting result.

6. The method as claimed in claim 5, wherein the first or second sensor is an optical interference sensor.

7. The method as claimed in claim 5, wherein the first or second sensor is an inductive transducer.

8. The method as claimed in claim 5, wherein the output signals of the first sensor and the second sensor include information of surface topography of the workpiece and positions of the first sensor and the second sensor.
